(19) United States
(12) Patent Application Publication
(10) Pub. No.: US 2022/0058598 A1
(43) Pub. Date: Feb. 24, 2022

(54) NOVEL CURRENCY AND METHOD OF USING THE SAME

(71) Applicant: William Ma, Zionsville, IN (US)

(72) Inventor: William Ma, Zionsville, IN (US)

(21) Appl. No.: 17/299,417

(22) PCT Filed: Nov. 18, 2020
(86) PCT No.: PCT/US20/60983

§ 371 Date: Jun. 3, 2021

Related U.S. Application Data
(60) Provisional application No. 62/937,106, filed on Nov. 18, 2019.

(51) Int. Cl. G06Q 20/06; G06Q 20/38

(52) U.S. Cl. CPC G06Q 20/0658; G06Q 20/389

(57) ABSTRACT

A currency, said currency having a value associated with a value of a commodity money or an exchange traded fund (ETF), wherein the commodity money or ETF has a value associated with an underlying commodity. The commodity money or ETF may be any commodity ETF or mutual fund including, but not limited to, a precious metal, non-precious metal or any metal, energy, livestock and meat, and agricultural, etc. commodity. The currency is digital currency, that is, not in a physical form such as a printed currency. Each unit of currency may have a unique identifier. The currency may be stored in the block chain. A a system or exchange of distributing the currency purchases and sells said commodity money/ETF in response to exchanges in out and of the currency. A purchase of goods or services using the currency results in a bookkeeping entry to track ownership of the currency.

### PRIORITY

The present patent application is related to, and claims the priority benefit of, U.S. Provisional Patent Application Ser. No. 62/937,106, filed on Nov. 18, 2019, the contents of which are hereby incorporated by reference in their entirety into this disclosure.

### BACKGROUND

Various types of “money” currently exist around the world. Examples of said monies are:

Commodity Money: this type of money closely relates to, and originates from, a barter system, which has a value defined by the intrinsic value of the underlying commodity itself, such as, for example, gold coins, beads, shells, spices, and the like.

Fiat Money: this type of money has its value (legal tender) declare by a government, requiring all people and firms within the country to accept it as a means of payment. Fiat money is not backed by any physical commodity, and its intrinsic value is significantly lower than its face value (as its value is derived from the relationship between supply and demand).

Fiduciary Money: this type of money has a value that depends on the confidence that it will be generally accepted as a medium of exchange. It is not declared legal tender by the government, and therefore people and firms are not required by law to accept it as a means of payment. The issuer of fiduciary money agrees to exchange it back for a commodity or fiat money if requested by the bearer, such as via checks, banknotes, drafts, and the like.

Commercial Bank Money: this type of money involves claims against financial institutions that can be used to purchase goods or services. This is a portion of a currency that is made of debt generated by commercial banks, and is created through what is generally referred to as “fractional reserve banking.”

A hybrid currency, providing more flexibility and a true basis for value, would be well received in the marketplace.

### BRIEF SUMMARY

The present disclosure includes disclosure of a currency, said currency having a value associated with a value of a financial product selected from the group consisting of a commodity money and an exchange-traded fund (ETF), wherein the financial product has a value associated with an underlying commodity.

The present disclosure includes disclosure of a currency having a value associated with a value of a financial product, wherein the financial product is a commodity money.

The present disclosure includes disclosure of currency having a value associated with a value of a commodity money, wherein the commodity money is a precious metal commodity money.

In an exemplary currency, the precious metal commodity money may be one from the group of commodity monies comprising platinum commodity monies, gold commodity monies, silver commodity monies, and copper commodity monies.

In an exemplary currency, the commodity money is is gold commodity money, and the underlying commodity is gold.

The commodity money may also be a commodity money other than a precious metal commodity money.

In another exemplary currency, the financial product is the ETF. The ETF may be a precious metal ETF. The precious metal ETF may be on from the the group of ETFs consisting of platinum ETFs, gold ETFs, silver ETFs, and copper ETFs.

In an exemplary currency the ETF is a gold ETF, and the underlying commodity is gold.

In another exemplary currency the ETF is not a precious metal ETF.

In an exemplary currency the ETF is an oil ETF, and the underlying commodity is oil.

The present disclosure includes disclosure of a currency, said currency having a value associated with a value of a financial product selected from the group consisting of a commodity money and an exchange-traded fund (ETF), wherein the financial product has a value associated with an underlying commodity, wherein the currency comprises at least one unit, each at least one unit of currency corresponding to a fraction of a unit of commodity money.

In another exemplary embodiment, the currency is a digital currency.

In another exemplary embodiment, an owner of the currency has an electronic/digital indication that identifies an amount of currency owned by said owner.

In an exemplary embodiment, the currency comprises at least one unit, wherein each of the at least one unit has a unique identifier.

In an exemplary embodiment, the currency is stored using block chain technology.

In an exemplary embodiment of a method of using a system or exchange to distribute the currency, the method comprises the steps of: purchasing a first amount of commodity money in response to an exchange into a first amount of currency, wherein a value of the first amount of commodity money is equivalent to a value of the exchange into the first amount of currency; selling a second amount of commodity money in response to an exchange out of a second amount of currency, wherein a value of the second amount of commodity money is equivalent to a value of exchange out of the second amount of currency; and making a general bookkeeping entry into a ledger representative of a transfer of ownership of a third amount of currency when the third amount of currency is used to purchase goods or services.

In an exemplary embodiment of a method of using a system or exchange to distribute the currency, a unit of currency is equal to a fraction of a unit of the commodity money.

In an exemplary embodiment of a method of using a system or exchange to distribute the currency, the currency comprises at least one unit, wherein each of the at least one unit has a unique identifier.

In an exemplary embodiment of a method of using a system or exchange to distribute a currency, the commodity money has a unit value, and the unit value of commodity money fluctuates.

The present disclosure includes disclosure of a currency, said currency having a value associated with a value of a commodity money, wherein the commodity money has a value associated with an underlying commodity.

The present disclosure includes disclosure of a currency, wherein the commodity money is a precious metal commodity money.

The present disclosure includes disclosure of a currency, wherein the precious metal commodity money is selected from the group of commodity monies comprising platinum commodity monies, gold commodity monies, silver commodity monies, and copper commodity monies.

The present disclosure includes disclosure of a currency, wherein the commodity money is not a precious metal commodity money.

The present disclosure includes disclosure of a currency, wherein the commodity money is gold commodity money, and wherein the underlying commodity is gold.

The present disclosure includes disclosure of a currency, said currency having a value associated with a value of an exchange-traded fund (ETF), wherein the ETF has a value associated with an underlying commodity.

The present disclosure includes disclosure of a currency, wherein the ETF is a precious metal ETF.

The present disclosure includes disclosure of a currency, wherein the precious metal ETF is selected from the group of ETFs comprising platinum ETFs, gold ETFs, silver ETFs, and copper ETFs.

The present disclosure includes disclosure of a currency, wherein the ETFs is not a precious metal ETFs.

The present disclosure includes disclosure of a currency, wherein the ETFs is gold ETFs, and wherein the underlying commodity is gold.

The present disclosure includes disclosure of a commodity money, as described herein.

The present disclosure includes disclosure of a method of using a commodity money, as described herein.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 is a block diagram illustrating the relative values of an exemplary embodiment of the disclosed currency.

An overview of the features, functions and/or configurations of the components depicted in the various FIGURES will now be presented. It should be appreciated that not all of the features of the components of the figures are necessarily described. Some of these non-discussed features, such as various couplers, etc., as well as discussed features are inherent from the FIGURES themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a novel currency. An exemplary novel currency 100 of the present disclosure may be referred to herein as currency 100, coin 100, and the like.

Currency 100 of the present disclosure is not a physical currency, as it exists in non-physical form. For example, an owner of currency 100 would have an electronic/digital indication 102 that identifies an amount of currency 100 owned by said owner.

Currency 100 of the present disclosure may have a value associated with a value of a financial product, wherein said financial product encompasses products such as commodity money or an exchange-traded fund (ETF) and said financial product has a value associated with an underlying commodity.

Currency 100 of the present disclosure has a value that is tied to a value of a commodity, such as gold, silver, platinum, copper, etc., which are known in the art. For example, currency 100 could be in the form of 1.00 coins, whereby 1.00 coins equals a fraction of a unit 152 of commodity money 150, such as ½, ⅓, ¼, ⅕, 1/10, 1/20, 1/25, 1/50, 1/100, 1/500, 1/1000, etc., of a unit 150 of a commodity money 150. Exemplary commodity monies 150 of the present disclosure may comprise commodity exchange-traded funds (ETFs) or other commodity monies 150 known in the art.

By way of example, and at the time of the present disclosure, there are over a dozen gold ETFs (exemplary commodity monies 150 of the present disclosure), which have a unit 152 value tied to the value of the underlying commodity 200 (gold, in this example). One such gold ETF is the Van Eck Merk Gold Trust, otherwise known by the abbreviation OUNZ. The current unit 152 value of one unit of OUNZ (one unit 152 of an exemplary commodity money 150 of the present disclosure) is US $14.37/share, at the time of drafting the present section of text. Said unit 152 value/price is equivalent (or substantially equivalent) to the value of 1/100 ounces of 24k gold (an exemplary underlying commodity 200). As such, when gold is valued at $1,437.00 per ounce (an exemplary unit 202 of the underlying commodity 200), one unit of OUNZ is valued at 1/100 of that value, or $14.37/share.

So, and in brief summary in the example of OUNZ noted above, if the value of one ounce of gold is $1,437.00 (the unit 202 value of the underlying commodity 200 is $1,437.00), then the value of one share of OUNZ is $14.37 (the unit 152 value of the commodity money 150 is $14.37).

An exemplary currency 100 of the present disclosure, such as being referred to as a coin 100 of the present disclosure, can have a unit 102 value of a fraction of the unit 152 value of the exemplary commodity money 150. For example, and exemplary coin 100 of the present disclosure could have a unit 102 value of 1/100 of the unit 152 value of the exemplary commodity money 150. Using the OUNZ example, and if one unit 102 (so 1.00 coin) has a unit 102 value of 1/100 of the unit 152 value of OUNZ, then one unit 102 (1.00 coin) of currency 100 would have a unit 102 value of $0.1437.

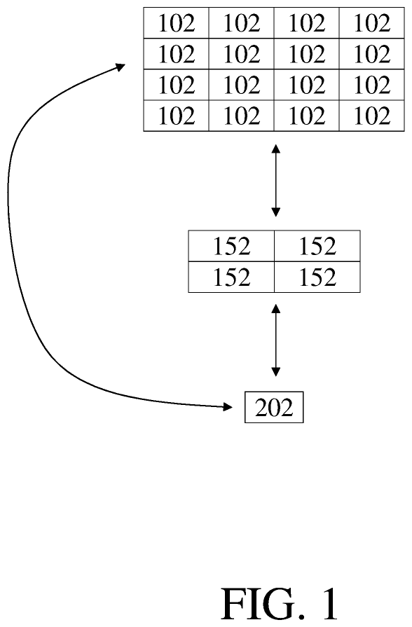

FIG. 1 is a block diagram of another exemplary currency, where the double headed arrows indicate equivalent values. As shown in FIG. 1, the unit 102 value of the currency is ¼ of the unit 152 value of the associated commodity money, and the unit 152 value of the commodity money is ¼ of the unit 202 value of the underlying commodity. So as illustrated in FIG. 1, the value of sixteen units 102 of currency is equivalent to the value of four units 152 of the associated commodity. The value of four units 152 of the commodity money is equivalent to the value of one unit 202 of the underlying commodity, and the value of one unit 202 of the underlying commodity is equivalent to the value of sixteen units 102 of the currency.

Furthermore, it is noted that an exemplary currency 100 can fluctuate in unit 102 value based upon fluctuations in the unit 152 value of the underlying commodity money 150. For example, if one share of OUNZ is $14.00 (where one ounce of gold is valued at $1,400.00), and if one unit 102 of currency 100 has 1/100 of the value 152 of OUNZ (so $0.14), and it is purchased/obtained at that price, it could ultimately be sold for $0.14 or more or less than $0.14. In this example, and if the price of gold increases to $1,600 (so the unit 202 value of the underlying commodity 200 is $1,600), then one unit 152 of OUNZ (an exemplary commodity money 150) has a value of $16.00, and then one unit 102 of currency 100 has a value of $0.16 and can be exchanged for $0.16. If the price of gold decreases in this example, then one unit 102 of currency 100 could have a value of less than $0.14, and therefore could be sold for less than $0.14.

Currencies 100 of the present disclosure, and unlike bitcoin (and other cryptocurrencies), are not “mined” or “printed out of thin air” so to speak. As noted above, currencies 100 of the present disclosure have a value based upon the values of the underlying ETFs (for example) and commodities, whereby an increased demand for the commodity would increase the values of the ETFs (for example) and currencies 100 tied thereto. In view of the same, when dollars are used to “purchase” the coins (currencies 100), the system or exchange 110 involved with said currency 100 would also actually own the underlying ETF. As such, and until an actual withdrawal/exchange of said currency 100 into dollars, Euros, etc., then the ETF (the commodity money 150) is actually sold so the owner of the currency 100 can be credited with the correct currency. However, if the owner of the currency 100 decides to purchase goods or services using said currency, there would be no purchase or sale of the underlying ETF (commodity money), as only a ledger or general bookkeeping of the coins would be made.

The fractions of a unit 152 of commodity money 150, and the fractions of a unit 102 of currency 100, of the present disclosure can be any desired fraction or percentage. The percentages referenced herein are for reference only and are not intended to be exhaustive.

Each unit 102 of currency 100 of the present disclosure would have a unique identifier 110, such as a unique serial number or other unique identifier. Such a unique identifier 110 allows an owner of currency 100 to keep track of each unit 102 of currency 100, which can then be redeemed for value, such as in a business to business (B2B), business to consumer (B2C), or a consumer to consumer (C2C) transaction, whereby said value of a unit 102 of currency 100 is tied to the value of the underlying unit 152 of commodity money.

Exemplary currency 100 of the present disclosure, in various embodiments, can be considered as a hybrid type of currency, namely a hybrid of commodity money 150 and fiduciary money. Storage of exemplary currency 100 of the present disclosure can utilize block chain technology.

As noted above, the underlying commodities and ETFs may be non-gold and also non-precious metals commodities and ETFs. That is, the currency can be associated with commodities that are not precious metals such as oil, natural, gas, grains, beef, etc. It is within the scope of the disclosure that the underlying commodity may be any commodity as known in the art, such as any metal, energy, livestock and meat, and agricultural, etc. commodity. It is envisioned that the commodity monies of the present disclosure could be any commodity ETF or mutual funds.

While various embodiments of currencies and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A currency, said currency having a value associated with an exchange-traded fund (ETF), wherein the ETF has a value associated with an underlying commodity.

2.-7. (canceled)

8. The currency of claim 1 wherein the currency is a digital currency.

9. The currency of claim 8, wherein an owner of the currency has an electronic/digital indication that identifies an amount of currency owned by said owner.

10. The currency of claim 8, wherein the currency comprises at least one unit, wherein each of the at least one unit has a unique identifier.

11. The currency of claim 10, wherein the currency is stored using block chain technology.

12. (canceled)

13. The currency of claim 1, wherein the ETF is a precious metal ETF.

14. (canceled)

15. The currency of claim 1, wherein the ETF is not a precious metal ETF.

16. (canceled)

17. The currency of claim 15, wherein the ETF is an oil ETF, and
wherein the underlying commodity is oil.

18.-21. (canceled)

22. A currency, said currency having a value associated with a value of a single commodity money, wherein the commodity money has a value associated with an underlying commodity.

23. The currency of claim 22, wherein the commodity money is a precious metal commodity money.

24. The currency of claim 23, wherein the precious metal commodity money is selected from the group of commodity monies comprising platinum commodity monies, gold commodity monies, silver commodity monies, and copper commodity monies.

25. The currency of claim 22, wherein the commodity money is not a precious metal commodity money.

26. (canceled)

27. The currency of claim 22, wherein the currency comprises at least one unit, each at least one unit of currency corresponding to a fraction of a unit of commodity money.

28. The currency of claim 22, wherein the currency is a digital currency.

29. (canceled)

30. The currency of claim 28, wherein the currency comprises at least one unit, wherein each of the at least one unit has a unique identifier.

31. The currency of claim 30, wherein the currency is stored using block chain technology and wherein the currency is not created through mining.

32.-37. (canceled)

38. A method of using a system or exchange to distribute a currency:
wherein the currency is a digital currency and has a value associated with a value of a financial product selected from the group consisting of a single commodity money and an ETF, wherein the financial product has a value associated with an underlying commodity,
the method comprising the steps of:
purchasing a first amount of the financial product in response to an exchange into a first amount of currency, wherein the value of the first amount of the financial product is equivalent to the value of the exchange into the first amount of currency;
selling a second amount of the financial product in response to an exchange out of a second amount of currency, wherein the value of the second amount of the financial product is equivalent to the value of exchange out of the second amount of currency; and
making a general bookkeeping entry into a ledger representative of a transfer of ownership of a third amount of currency when the third amount of currency is used to purchase goods or services.

39. The method of using a system or exchange to distribute a currency as in claim 38 wherein a unit of currency is equal to a fraction of a unit of the financial product.

40. The method of using a system or exchange to distribute a currency as in claim 38 wherein the currency comprises at least one unit, wherein each of the at least one unit has a unique identifier.

41. The method of using a system or exchange to distribute a currency as in claim 38 wherein the financial product has a unit value, and the unit value of the financial product fluctuates.
